(19) United States
(12) Patent Application Publication
(10) Pub. No.: US 2016/0309411 A1
(43) Pub. Date: Oct. 20, 2016

(54) DYNAMIC UNGROUPING OF IP PACKETS BEFORE CELLULAR TRANSMISSION

(71) Applicant: NOKIA TECHNOLOGIES OY, Espoo (FI)

(72) Inventors: Teemu Ilmari Savolainen, Nokia (FI); Simo Pekka Veikkolainen, Masala (FI)

(21) Appl. No.: 15/100,610

(22) PCT Filed: Dec. 5, 2013
(86) PCT No.: PCT/US2013/073431

§ 371 Date: May 31, 2016

(51) Int. Cl. H04W 52/02; H04W 24/08; H04L 12/751

(52) U.S. Cl. CPC H04W 52/0209; H04L 45/026; H04W 24/08; H04W 88/02

(57) ABSTRACT

Methods and apparatus, including computer program products, are provided for dynamic ungrouping. In one aspect there is provided a method. The method may include determining, at a user equipment, whether a packet transmission to a network will cause the user equipment to transition from a first power consumption state to a second power consumption state; sending, by the user equipment, the packet, when the packet transmission will not cause the user equipment to transition to the second power consumption state; sending, by the user equipment, the packet, when the packet transmission will cause the user equipment to transition to the second power consumption state and the packet is delay intolerant; and delaying, by the user equipment, the packet transmission, when the packet transmission will cause the user equipment to transition to the second power consumption state and the packet is delay tolerant.

### FIELD

The subject matter described herein relates to wireless communications.

### BACKGROUND

Some mobile platforms may implement a mechanism called a heartbeat, which collects a number of small data transactions, such as keep-alive messages, polling requests, and the like, to form a group for transmission to the network. Grouping may minimize the number of times the radio is activated for short packet exchanges and may thus reduce power consumption at the mobile platform.

### SUMMARY

Methods and apparatus, including computer program products, are provided for dynamic ungrouping.

In one aspect there is provided a method. The method may include determining, at a user equipment, whether a packet transmission to a network will cause the user equipment to transition from a first power consumption state to a second power consumption state; sending, by the user equipment, the packet, when the packet transmission will not cause the user equipment to transition to the second power consumption state; sending, by the user equipment, the packet, when the packet transmission will cause the user equipment to transition to the second power consumption state and the packet is delay intolerant; and delaying, by the user equipment, the packet transmission, when the packet transmission will cause the user equipment to transition to the second power consumption state and the packet is delay tolerant.

In some variations, one or more of the features disclosed herein including the following features can optionally be included in any feasible combination. The first power consumption state may represent a low power consumption state. The low power consumption state may comprise transmission via a forward access channel. The second power consumption state may comprise a high power consumption state higher than the first power consumption state. The high power consumption state may comprise transmission via a dedicated channel. The determining may be based on network behavior information. The network behavior information may be at least one of obtained from the network and learned by at least one of a client application, the user equipment, and a processor configured to learn network behavior. The user equipment may comprise at least one of a constrained application protocol node, a constrained application protocol server, and a constrained application protocol client. The transition may include switching to another radio access technology. The user equipment may monitor one or more radio state transfers to learn at least one of a packet size, a packet transmission interval, and a window size that triggers a transition from the first power consumption state to the second power consumption state. The power consumption of the user equipment may be measured to learn power consumption related to transmission or reception.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF THE DRAWINGS

In the drawings,

FIGS. 1-6 depict examples of power consumption versus time plots for various packet transmission schemes;

FIG. 7 depicts an example process for ungrouping packets, in accordance with some example embodiments;

FIGS. 8-12 depict examples of plots related to learning of network behavior, in accordance with some example embodiments;

FIG. 13 depicts an example system including a smart object configured to ungroup packets, in accordance with some example embodiments; and

FIG. 14 depicts an example of a user equipment, in accordance with some example embodiments.

Like labels are used to refer to same or similar items in the drawings.

### DETAILED DESCRIPTION

When a small burst of data is sent via for example Internet Protocol (IP) packets, a user equipment, such as a smartphone and the like, may unnecessarily consume power if the data burst causes the user equipment to change into a high power consumption state, such as transmission/reception via a dedicated channel (DCH), when compared to operating in a lower power consumption state, such as transmission/reception via Forward Access Channel (FACH).

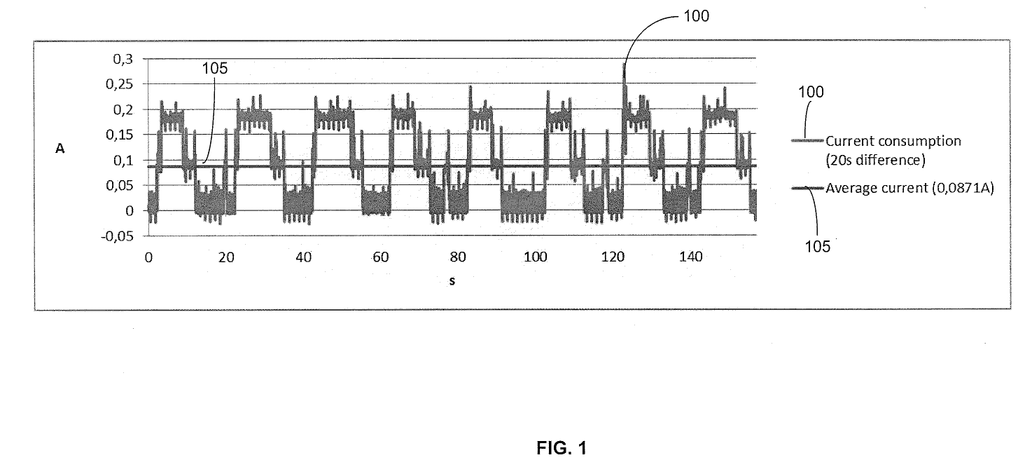

FIG. 1 depicts an example plot 100 of frequent data transmissions of IP packets that cause the user equipment (for example, a radio therein) to often go into a higher power consuming state. In the example of FIG. 1, the average power consumption is about 0.0871 amps as shown at 105.

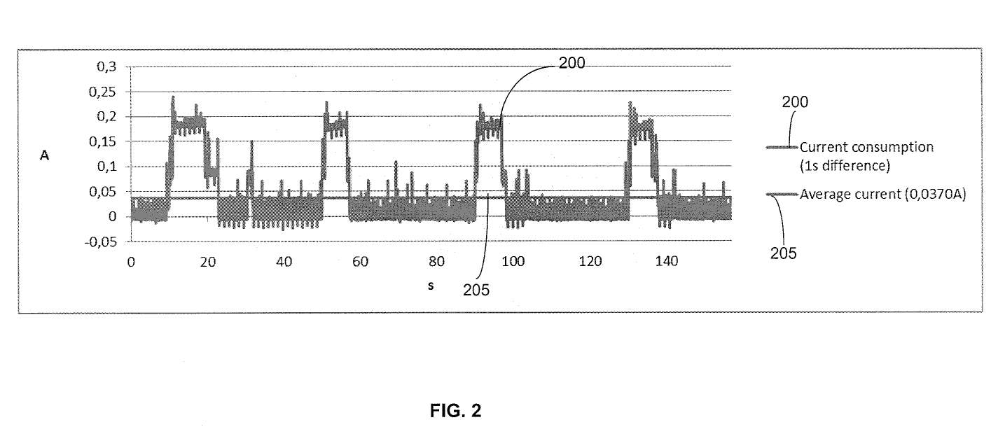

FIG. 2 depicts an example plot 200 of the data transmissions of FIG. 1, but in the case of FIG. 2, grouping is used to reduce the average power consumption,to about 0.0370 amps as shown at FIG. 2 at 205.

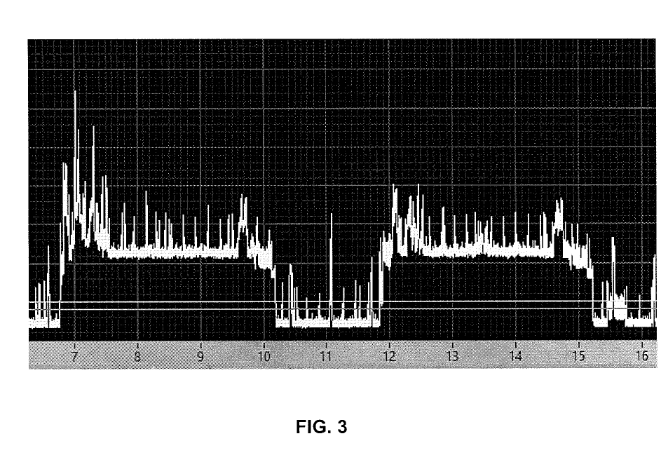

FIGS. 3-6 show example plots in which two 111-byte packets are sent in different intervals.

FIG. 3 shows a plot having an X-axis representing time in seconds and a Y-axis representing energy consumed by the user equipment. At FIG. 3, the two 111-byte packets are sent within 5-second intervals. Both 111-byte packets are sent in a lower power FACH channel, and the radio is activated twice for a 3-second period.

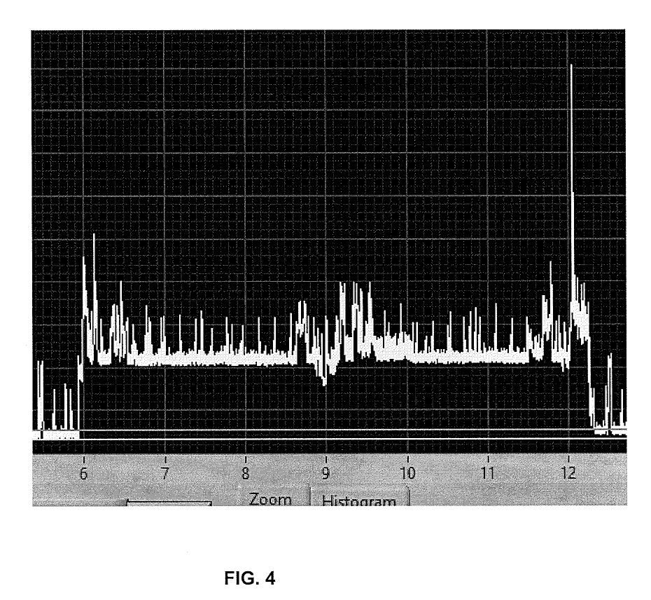

FIG. 4 depicts a plot wherein the two 111-byte packets are sent 3 seconds apart, and the radio is activated once for about 6 seconds in FACH. The power consumption at FIG. 4 is similar to the power consumption of FIG. 3.

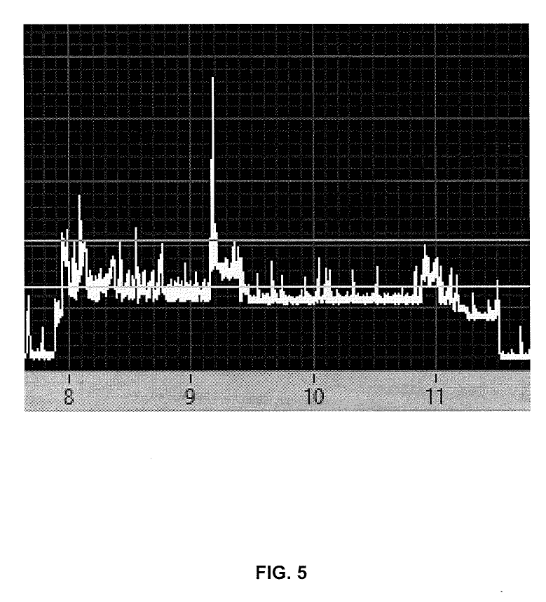

FIG. 5 depicts a plot wherein the two 111-byte packets are sent 600 milliseconds (ms) apart. The radio is on once for only 3.6 seconds, and stays in FACH. At FIG. 5, the radio consumes less energy than at FIGS. 3 and 4 due to the shorter on time.

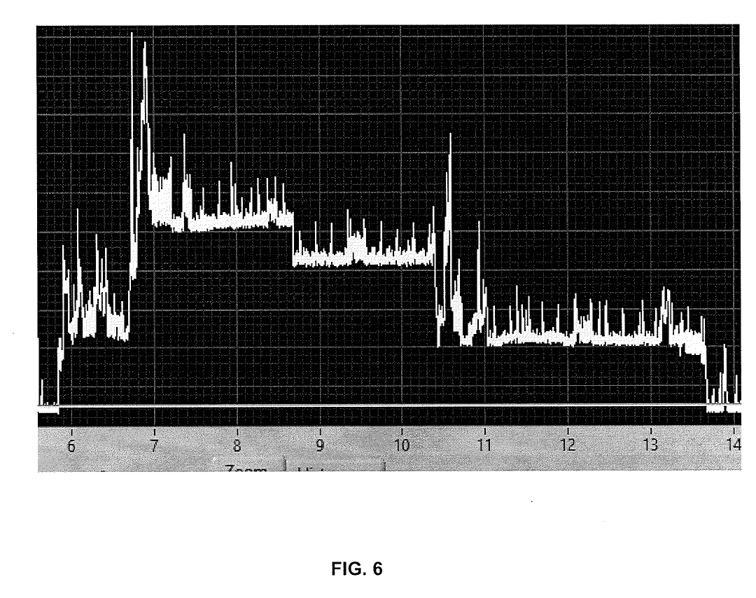

FIG. 6 depicts a plot wherein the two 111-byte packets are sent 400 ms apart. However, at FIG. 6 the radio changes state to a high power DCH state. Moreover, the radio is active for a total of 8 seconds. As such, FIG. 6 requires the most energy, when compared to FIGS. 3-6, as the power consumption is highest when the DCH channel is used and the radio does not return promptly to Idle but instead moves to FACH channel for an additional 2 seconds before returning to Idle state.

FIGS. 3-6 show that sending packets close to each other is generally good from a power consumption standpoint, so long as the packet grouping does not trigger a jump to a high power consuming state, such as the use of the DCH channel. Moreover, grouping packets too closely may be unnecessary, as some packets may be more tolerant of delay, so these packets may be ungrouped and thus sent with higher intervals. To illustrate, a user equipment may be running one or more applications that perform small data transactions at the same time, and these small transaction may be driven by a heartbeat mechanism. For example, the small transactions may correspond to a phone acting as a router or a so-called “smart object” of Internet of Things. In the latter case, the smart object may use for example a cellular uplink/downlink to send/receive multiple packets, so avoiding unnecessary jumps to higher power consumptions states, such as DCH, may improve the ability of the smart object to reduce power consumption.

In some example embodiments, the user equipment (or an IP stack therein) may actively attempt to spread (for example, ungroup) outgoing IP packets over a period of time in a manner that allows sending of the IP packets with a lower amount of energy consumed. For example, the user equipment may delay forwarding or delay generation of new IP packets, when deferring the packet sending is determined to be cheaper in terms of energy consumed at the user equipment. In some example embodiments, the new IP packets may be retransmissions of previously sent IP packets, and the user equipment may then delay sending of these retransmissions.

To learn timers, counters, and the like related to a cellular network's radio power states, the user equipment (or IP stack therein) may actively monitor the radio state transfers and measure the related power consumption during sending and/or receiving different sized packets to learn what packet sizes, intervals, and window sizes are cheaper (from a power consumption perspective). For example, a user equipment may actively learn where network thresholds are for changing radio state from FACH to DCH and/or whether fast dormancy is available.

A user equipment may learn the power/energy consumption related to data transactions by for example monitoring battery current consumption for the duration of the transactions. As an example, in the user equipment an application may provide battery current and voltage monitoring over time and logging of the monitored information. Logged instantaneous current and voltage measurements, current battery charge, and corresponding time stamps may be correlated with transmission (and/or reception) transactions and/or state change information to determine power consumption caused by the transmission and reception under different size, window, and intervals. Furthermore, the power consumption information may be correlated to network type, for example 2G, 3G, 4G, or WiFi, to a geo-location, to a network operator, to a cell identifier, and/or any other like information.

Although the previous example describes the user equipment actively monitoring state changes, this information may be obtained in other ways. For example, the user equipment may indirectly monitor what causes a state change in a network by obtaining power consumption information or network configuration information. This information may be available via the network (for example, a network operator database, a remote server/database, and the like) or via a source of information at the user equipment (for example, a SIM-card, files containing preconfigured (un)grouping rules, and the like).

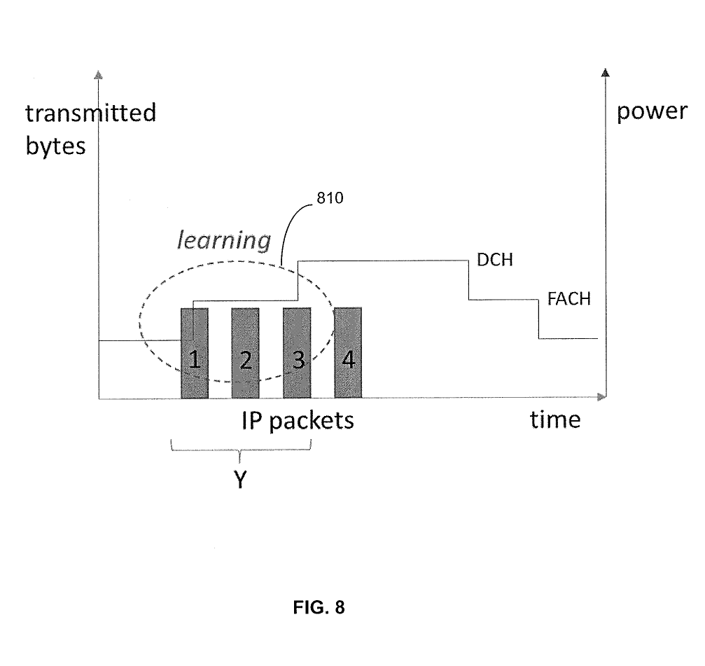

In some example embodiments, the user equipment may implement a specific active learning procedure, an example of which is described below with respect to FIGS. 8-12. When this is the case, the user equipment may send IP packets with different sizes and intervals to learn a network's behavior.

In some example embodiments, the user equipment may implement machine-learning algorithms, such as logistic regression, artificial neural networks, or the like, to learn by experience how to optimize packet transmissions in order to minimize power consumption. Furthermore, in some example embodiments, the user equipment may actively try to use radio access technologies (for example, 2G, 3G, 4G, WiFi, and the like) in order to obtain information of which radio technology is the most power efficient and hence which should be used. The learning algorithm may take one or more inputs for the learning procedure, such as geo-location, time, network cell identifier, radio signal strengths, and the like. In some example embodiments, the machine-learning procedure may be performed outside of the user equipment, such as at the time of the user equipment development or any other time as well. In such a case, the user equipment may include the learnings of machine-learning procedure and apply the learnings when taking certain actions to for example group, ungroup, and the like. A mixed approach may also be implemented, such that learning may be performed at the time of manufacture to determine a default optimization set of rules, which are then updated via learning as per gained experience.

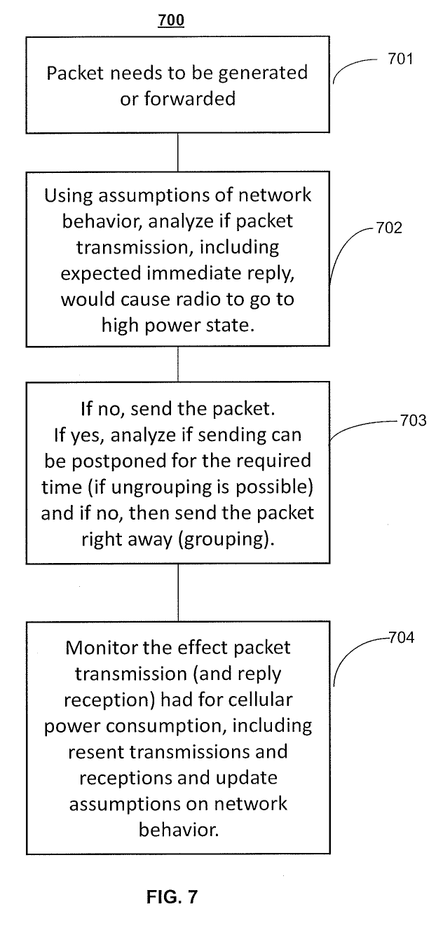

FIG. 7 depicts an example process 700 for ungrouping packets, in accordance with some example embodiments.

At 701, a user equipment may have one or more packets that need to be forwarded and/or generated to a network. When this is the case, at 702 the user equipment may analyze, based on network behavior information, if transmission of the one or more packets (or the expected reply) may cause the user equipment to go to a high power consumption state, such as DCH. The network behavior information may include information such as the packet size, transmission intervals, and/or window sizes indicative of whether sending one or more packets may cause, in the network, a transition from a lower power consumption state, such as FACH transmission, to a higher power consumption state, such as DCH transmission. This network behavior information may be provided by the network, learned by the user equipment, and/or obtained in any other way.

At 703, the one or more packets may be forwarded (without ungrouping delay), when 702 determines that there is no cheaper alternative. For example, if sending the packet would not cause a jump to a higher power consumption state, the user equipment may send the one or more packets without an ungrouping delay.

At 703, if the result of the analysis at 702 indicates that it would be cheaper (in terms of power consumption) to delay the forwarding transaction, the user equipment may delay the transmission by an amount of time required to achieve a lower power consumption. For example, if delaying transmission of a packet may allow the user equipment to stay in FACH, the user equipment may ungroup the packet by delaying the transmission of that packet by a certain amount of time.

However, if the result of the analysis at 702 indicates that it would be cheaper (in terms of power consumption) to delay the forwarding transaction but the packet is not delay tolerant (for example, the packet transmission cannot be delayed to accommodate ungrouping), the user equipment may, at 703, send the packet to the network without delay.

At step 704, the user equipment may monitor the impact on power consumption caused by sending packets at 703 and/or receiving reply, and the impact may be used to update the network behavior information.

In some example embodiments, a learning procedure may be implemented to learn the network behavior with respect to power consumption state changes caused by sending packets and receiving corresponding replies. The learning may be performed by observing actual traffic or by generating test traffic patterns, including trying on different radio access types/network generations, such as 2G, 3G, 4G, WiFi, and the like. Moreover, the learning may be performed by a user equipment, the network, and/or any other device(s).

FIG. 8 shows a learning procedure in a network condition in which a third packet causes a user equipment's radio to change to DCH (or causes power consumption to rise sharply). For example, a device may learn 810 that sending of total X bytes (for example, a total size of packets 1+2+3) within time window of Y seconds is enough to take modem to higher consumption level. This learning 810 may be included in the network behavior information.

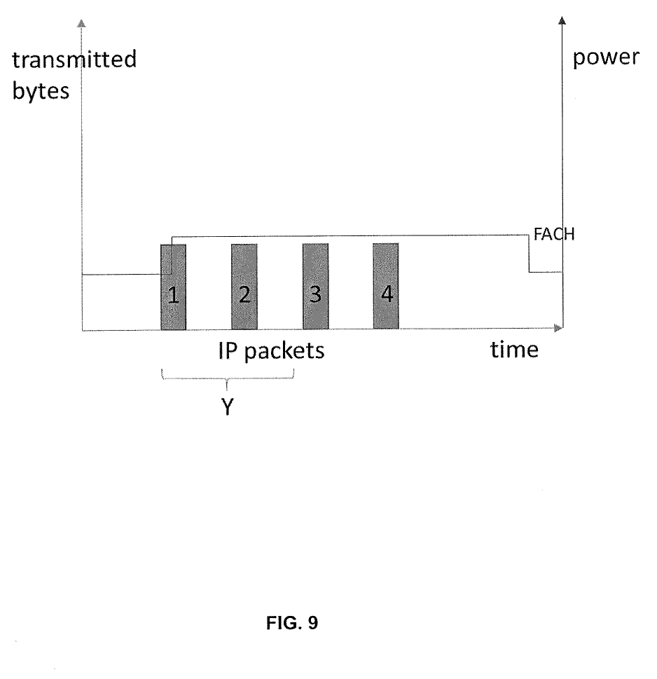

FIG. 9 shows the behavior of the device after learning in FIG. 8. In FIG. 9, the device may avoid causing a higher power consumption mode by sending packets with longer intervals and thus not sending X bytes in Y seconds that would otherwise cause the modem to shift to for example a higher power consuming DCH channel.

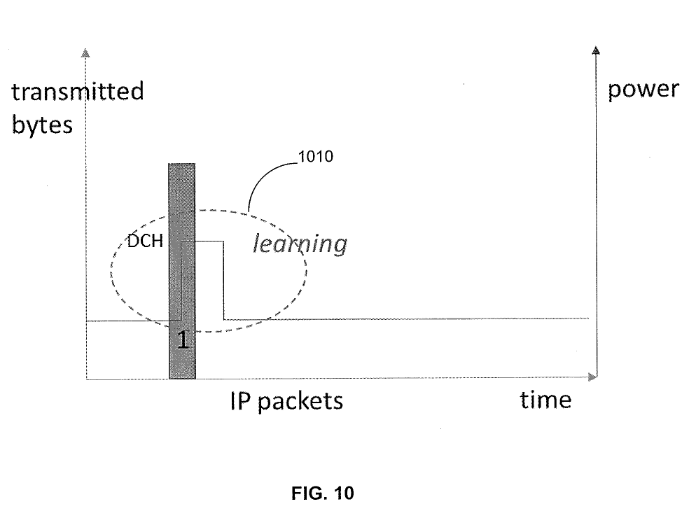

FIG. 10 shows a situation in which a device learns 1010 that a single packet (“1”) of size X causes a user equipment (or radio therein) to go to a higher power consumption state, such as DCH, but only for short duration (as the network may be utilizing fast dormancy). This learning 1010 may be included as part of the network behavior information.

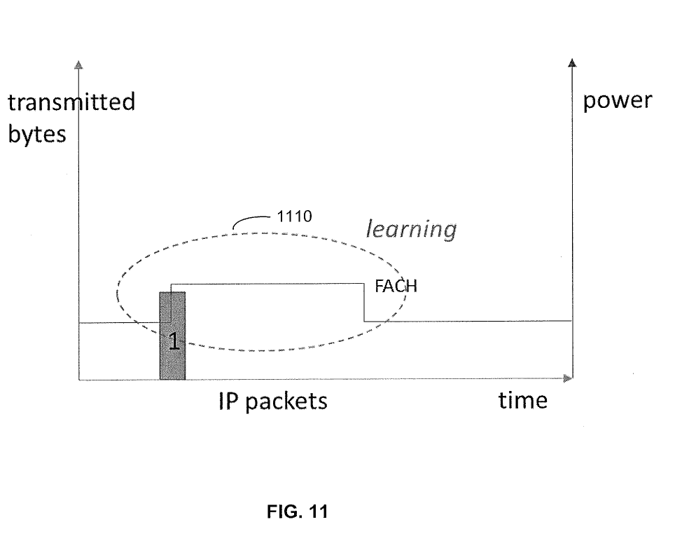

FIG. 11 shows a device that learns 1110 that single packet (1) of a size less than X may cause a user equipment (or radio therein) to go into a lower power consumption state, such as FACH, but for longer duration of time. In the example of FIG. 11, the packet may consume more energy when compared to FIG. 10, as the user equipment is on in FACH for a longer period of time. This learning 1110 may be included in the network behavior information.

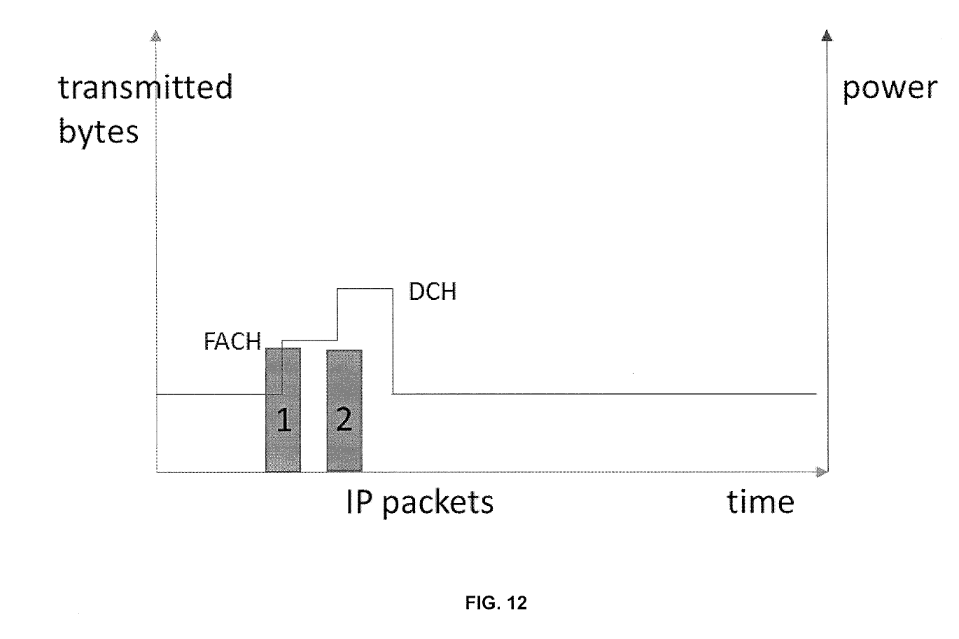

FIG. 12 shows that after a device learns 1010 and 1110 (FIGS. 10 and 11) and device has smaller packets to send, the device may attempt to group the packets in order to get to a higher power consuming state, such as DCH, from where a return to Idle happens faster, when compared to packets sent at FIG. 9. In this example, although the device, such as a user equipment, attempts to go to a higher power consuming state, such as DCH, overall total power consumed when compared to FIG. 9 (where the user equipment stays in a less power consuming state but stays in that lower consuming state for a longer time causing more overall power consumption).

Although packet transmission may be delayed in some instances but not in others, there are certain applications that may be more tolerant of delays associated with ungrouping. For example, a smart object which shares (or provides) information may be more tolerant of delays, and example of which is a wireless sensor providing sensor data to consuming devices.

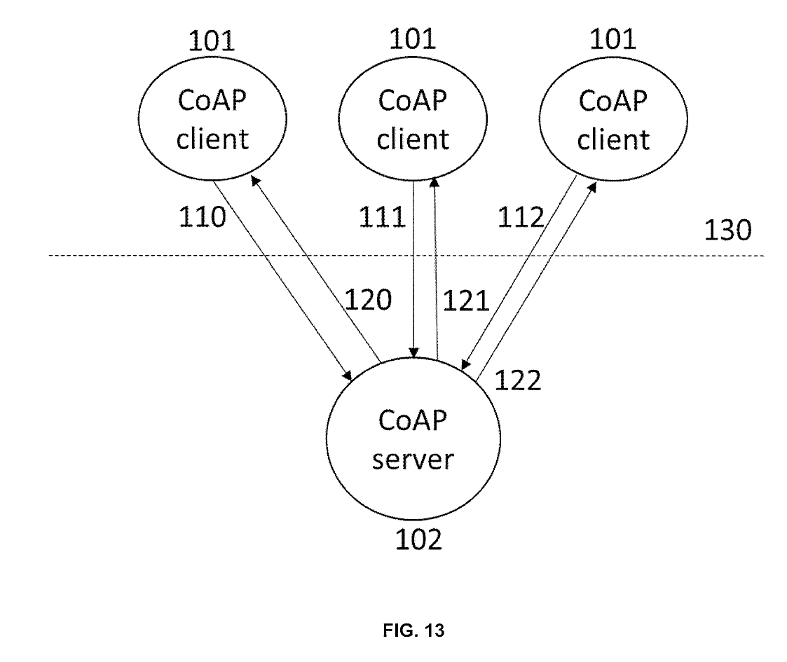

FIG. 13 depicts an example system including clients 101 and server 102, in accordance with some example embodiments. For example, a smart object may be implemented as a server, such as CoAP (constrained application protocol) server 102, and the consuming devices may be implemented as clients, such as CoAP clients.

The CoAP clients 101 may request the state of the smart object at CoAP server 102. When the CoAP server 102 receives requests and sends replies, the CoAP server 102 may implement process 700 in order to group and ungroup packets to minimize power consumption. This may save resources of the smart object, which may be operating by battery, an energy harvesting solution, and the like.

A client, such as application running on a user equipment, may have a need to observe status of multiple smart objects. This may be performed via CoAP, for example. An application may use CoAP implemented as a platform service, and this CoAP implementation may have access to information regarding an amount of traffic over the cellular interface. This may allow spreading (for example, ungrouping or delaying) of CoAP requests over a certain period of time to keep the smart object (or radio therein) in lower power consuming state, such as FACH, even when monitoring many smart objects simultaneously.

Referring to FIG. 13, a smart object may be implemented as CoAP server 102, which may serve CoAP clients 101. The communication between CoAP server 102 and CoAP clients 101 may take place over wireless links including for example cellular interface 130. The CoAP server may have little control as to when requests 110, 111 and 112 for information arrive from CoAP clients. However, the CoAP server may control sending of responses 120, 121 and 122. For simple request and response exchanges, the CoAP server may be limited by the requirement for a reasonably fast reply in order to avoid causing a client to perform retransmissions. But when the CoAP clients start to observe the status of the CoAP server's request, CoAP clients 101 may request that they want to receive updates periodically or when something changes. As such, when CoAP server 102 needs to send updates (as messages 120,121,122), CoAP server 102 may spread the updates/responses over time to ensure the cellular radio handling interface 130 does not go to high power consuming state.

In some example embodiments, ICMP (v6) message generation on a host may be in accordance with the ungrouping disclosed herein. For example, if a host needs to send ICMP(v6) replies or error messages (for example, due to being “pinged”), the host may send the replies ungrouped or distributed, so that overall power consumption stays in the lower power consuming FACH channel. This distribution may also assist in countering port scanning and the like, when compared to stopping the transmission of replies.

As noted above, retransmissions may take into account power consumption. For example, in case of CoAP messages, these messages may be retransmitted if not acknowledged, and the retransmission timer may be configurable in accordance with the ungrouping (for example, process 700 and the like) disclosed herein.

Moreover, a device may not send enough data to reach a higher power consuming DCH state (but knows that it might be useful due fast dormancy features), but the device may send filler (or garbage) bytes as part of a packet or as separate packet(s) in order to optimize radio behavior in accordance with process 700. For example, packet 2 of FIG. 12 may be a garbage packet.

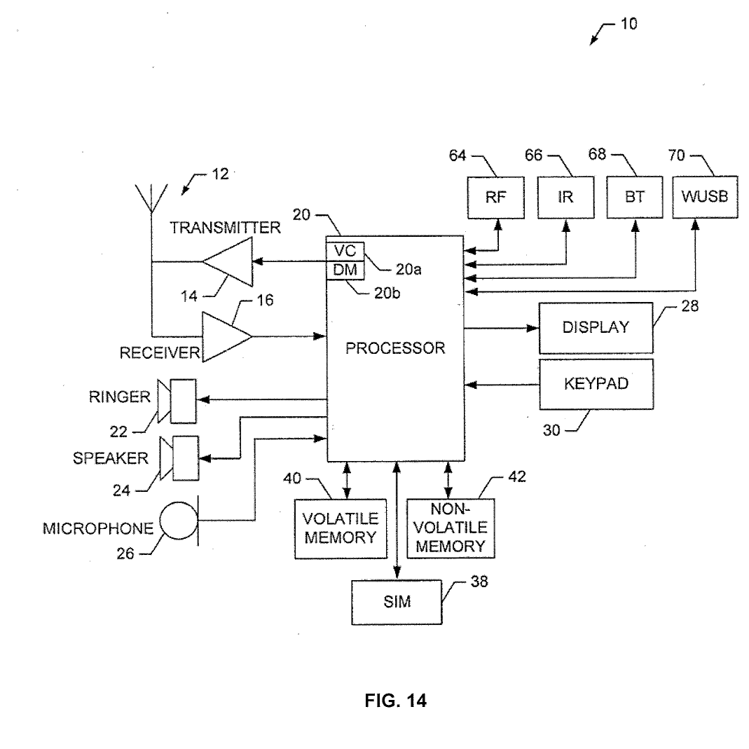

FIG. 14 illustrates a block diagram of an apparatus 10, in accordance with some example embodiments. For example, apparatus 10 may comprise a user equipment, such as a smart phone, smart object, mobile station, a mobile unit, a subscriber station, a wireless terminal, a tablet, a wireless plug-in accessory, a router, or any other wireless apparatus.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 14 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, Bluetooth, Bluetooth Low-Energy, Zigbee, Z-Wave, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, Constrained Application Protocol (CoAP), and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 14, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth (BT) transceiver 68 operating using Bluetooth wireless technology, a wireless universal serial bus (USB) transceiver 70, a Bluetooth Low Energy transceiver, a ZigBee transceiver, an ANT transceiver, a cellular device-to-device transceiver, a wireless local area link transceiver, and/or any other short-range radio technology. Moreover, in some example embodiments, the short-range transceiver may transmit advertisements (which may include the location change disclosed herein) generated by processor 20. Apparatus 10 and, in particular, the short-range transceiver may be capable of transmitting data to and/or receiving data from electronic devices within the proximity of the apparatus, such as within 10 meters, for example. The apparatus 10 including the WiFi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the user equipment/mobile terminal. The memories may comprise an identifier, such as an international mobile equipment identification (IMEI) code, capable of uniquely identifying apparatus 10. The functions may include one or more of the operations disclosed with respect to grouping an ungrouping, process 700, and the like. The memories may comprise an identifier, such as an international mobile equipment identification (IMEI) code, capable of uniquely identifying apparatus 10. In the example embodiment, the processor 20 may be configured using computer code stored at memory 40 and/or 42 to operations disclosed herein with respect to grouping, ungrouping, learning, process 700 and the like.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 14, computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein is that enhanced power savings.

Although some of the drawings depicts example results, other results (which may be actual or simulated) may be achieved as well.

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of the present invention as defined in the appended claims. Other embodiments may be within the scope of the following claims. The term “based on” includes “based on at least.” The use of the phase “such as” means “such as for example” unless otherwise indicated.

1-24. (canceled)

25. A method comprising:
determining, at a user equipment, whether a packet transmission to a network will cause the user equipment to transition from a first power consumption state to a second power consumption state;
sending, by the user equipment, the packet, when the packet transmission will not cause the user equipment to transition to the second power consumption state;
sending, by the user equipment, the packet, when the packet transmission will cause the user equipment to transition to the second power consumption state and the packet is delay intolerant; and
delaying, by the user equipment, the packet transmission, when the packet transmission will cause the user equipment to transition to the second power consumption state and the packet is delay tolerant.

26. The method of claim 25, wherein the first power consumption state represents a low power consumption state, and wherein the low power consumption state comprises transmission via a forward access channel.

27. A method as in claim 25, wherein the second power consumption state comprises a high power consumption state higher than the first power consumption state, and wherein the high power consumption state comprises transmission via a dedicated channel.

28. A method as in claim 25, wherein the determining further comprises:
determining based on network behavior information.

29. The method of claim 28, wherein the network behavior information is at least one of obtained from the network and learned by at least one of a client application, the user equipment, and a processor configured to learn network behavior.

30. A method as in claim 25, wherein the user equipment comprises at least one of a constrained application protocol node, a constrained application protocol server, and a constrained application protocol client.

31. A method as in claim 25 further comprising:
monitoring, by the user equipment, one or more radio state transfers to learn at least one of a packet size, a packet transmission interval, and a window size that triggers a transition from the first power consumption state to the second power consumption state.

32. A method as in claim 25 further comprising:
measuring power consumption of the user equipment to learn power consumption related to transmission or reception.

33. An apparatus, comprising:
at least one processor; and
at least one memory including computer program code, the at least one memory and the computer program code configured to, with the at least one processor, cause the apparatus to perform at least the following:
determine whether a packet transmission to a network will cause the apparatus to transition from a first power consumption state to a second power consumption state;
send the packet, when the packet transmission will not cause the apparatus to transition to the second power consumption state;
send the packet, when the packet transmission will cause the apparatus to transition to the second power consumption state and the packet is delay intolerant; and
delay the packet transmission, when the packet transmission will cause the apparatus to transition to the second power consumption state and the packet is delay tolerant.

34. The apparatus of claim 33, wherein the first power consumption state represents a low power consumption state.

35. The apparatus of claim 34, wherein the low power consumption state comprises transmission via a forward access channel.

36. An apparatus as in claim 33, wherein the second power consumption state comprises a high power consumption state higher than the first power consumption state.

37. The apparatus of claim 36, wherein the high power consumption state comprises transmission via a dedicated channel.

38. An apparatus as in claim 33, wherein network behavior information is used to determine whether the packet transmission to the network will cause the apparatus to transition.

39. The apparatus of claim 38, wherein the network behavior information is at least one of obtained from the network and learned by at least one of a client application, the apparatus, and a processor configured to learn network behavior.

40. An apparatus as in claim 33, wherein the apparatus at least one of a constrained application protocol node, a constrained application protocol server, and a constrained application protocol client.

41. An apparatus as in claim 33, wherein the transition includes switching to another radio access technology.

42. An apparatus as in claim 33, wherein the apparatus is further configured to at least monitor one or more radio state transfers to learn at least one of a packet size, a packet transmission interval, and a window size that triggers a transition from the first power consumption state to the second power consumption state.

43. An apparatus as in claim 33, wherein the apparatus is further configured to at least measure power consumption of the apparatus to learn power consumption related to transmission or reception.

44. A non-transitory computer-readable storage medium including computer program code which when executed by at least one processor causes operations comparing:
determining whether a packet transmission to a network will cause a user equipment to transition from a first power consumption state to a second power consumption state;
sending the packet, when the packet transmission will not cause the user equipment to transition to the second power consumption state;
sending the packet, when the packet transmission will cause the user equipment to transition to the second power consumption state and the packet is delay intolerant; and
delaying the packet transmission, when the packet transmission will cause the user equipment to transition to the second power consumption state and the packet is delay tolerant.
